(19) United States
(12) Patent Application Publication
(10) Pub. No.: US 2026/0134504 A1
(43) Pub. Date: May 14, 2026

(54) SCREEN OUTPAINTING FOR IMMERSIVE EXPERIENCES

(71) Applicants: DISNEY ENTERPRISES, INC., Burbank, CA (US); ETH Zürich (Eidgenössische Technische Hochschule Zürich), Zürich (CH)

(72) Inventors: Abdelaziz DJELOUAH, Zürich (CH); Martina N. MEGARO-BOLDINI, Ostermundigen (CH); Zhongrui YU, Zürich (CH)

(21) Appl. No.: 18/946,771

(22) Filed: Nov. 13, 2024

(51) Int. Cl. G06T 3/40; G06T 15/20; G06T 17/00

(52) U.S. Cl. CPC G06T 3/40; G06T 15/205; G06T 17/00

(57) ABSTRACT

The present invention sets forth a technique for performing screen outpainting. The technique includes receiving an input video sequence including one or more frames depicting a scene, identifying one or more static scene elements included in the scene, and generating a three-dimensional (3D) reconstruction of the scene based on the input video sequence and the one or more static scene elements. The technique also includes rendering one or more novel views of the scene based on the 3D reconstruction of the scene and generating one or more expanded frames, wherein each expanded frame includes a first region including visual content included in a frame included in the input video sequence, and one or more additional regions that each include visual content based on the one or more novel views of the scene. The technique further includes generating an output video sequence based on the one or more expanded frames.

### BACKGROUND

### Field of the Various Embodiments

Embodiments of the present disclosure relate generally to computer vision, video processing and, more specifically, to automated techniques for performing screen outpainting when displaying visual content.

### Description of the Related Art

Head Mounted Displays (HMDs) provide an immersive experience when viewing video content, as video content designed for viewing via an HMD may fill the entire field of view of the HMD, often extending horizontally up to 180 degrees or more in front of a viewer. Not all video content is designed for viewing via an HMD, including large quantities of existing legacy video content (e.g., movies or television shows) that were designed to be viewed via a conventional screen, such as a cinema or television screen. Such legacy video content, when viewed via an HMD, may not provide an immersive viewing experience, as the legacy video content may not fill the entire field of view of the HMD. In particular, if the legacy video content is scaled or otherwise resized to fill the vertical field of view of the HMD, the legacy video content may not fill the horizontal field of view of the HMD, leaving blank rectangular regions located on the left and right sides of the centered legacy video content. It is desirable to adapt legacy video content for viewing via an HMD, such that the presentation of the legacy video content fills the field of view of the HMD in both the vertical and horizontal dimensions.

Existing techniques for adapting legacy video content for viewing via an HMD may simply adapt the aspect ratio (i.e., the width-to-height ratio) of the legacy video content to match the field of view of an HMD. For example, existing techniques may preserve the height of the legacy video content while stretching the width of the legacy video content to match the horizontal field of view of the HMD. While these techniques may effectively fill the HMD's field of view with the legacy video content, the techniques introduce distortion from the horizontal stretching and may result in an unnatural appearance of objects, scenery, or people depicted in the legacy video content.

Other existing techniques may determine a largest possible rectangular region within the legacy video content, where the rectangular region exhibits the same aspect ratio as the HMD field of view. The techniques transmit only the legacy video content located within the determined rectangular region to the HMD. These techniques preserve the shape and relative dimensions of objects depicted in the legacy video content, but discard portions of the legacy video content that are not located within the determined rectangular region. These techniques are similar to converting a widescreen movie (e.g., having an aspect ratio of 16:9) for viewing on a screen having an aspect ratio of, e.g., 4:3. The conversion may entail simply cutting off the leftmost and rightmost portions of the widescreen content to produce content having the desired aspect ratio.

Still other existing techniques may fill blank regions located within the HMD's field of view with content that is different from the legacy video content while being visually compatible with the legacy video content. For example, a technique may fill the HMD's field of view with a still image and then overlay the legacy video content over the still image, such that the legacy video content occupies the center horizontal portion of the HMD's field of view while leaving the still image visible to the left and right sides of the legacy video content. A similar technique may statically or dynamically fill the blank regions in the HMD field of view with color, where the choice of color may be based on colors included in the legacy video content. While these techniques address the blank regions in the HMD's field of view, they may not provide an immersive experience, since the legacy video content still only occupies the center portion of the HMD's horizontal field of view.

As the foregoing illustrates, what is needed in the art are more effective techniques for adapting legacy video content for viewing via an HMD.

### SUMMARY

One embodiment of the present invention sets forth a technique for performing screen outpainting. The technique includes receiving an input video sequence including one or more frames depicting a scene and identifying one or more static scene elements included in the scene. The technique also includes generating a three-dimensional (3D) reconstruction of the scene based on the input video sequence and the one or more static scene elements, and rendering one or more novel views of the scene based on the 3D reconstruction of the scene. The technique further includes generating one or more expanded frames, wherein each expanded frame includes a first region including visual content included in a frame included in the input video sequence, and one or more additional regions that each include visual content based on the one or more novel views of the scene, and generating an output video sequence based on the one or more expanded frames.

One technical advantage of the disclosed techniques relative to the prior art is that the disclosed techniques are operable to extend an existing video sequence to fill the field of view of a head-mounted display (HMD) or other widescreen display without discarding or distorting content included in the existing video sequence. The disclosed techniques also generate extended video content that is both temporally and spatially consistent with the content of the existing video sequence, incorporating both static and dynamic elements included in the existing video sequence. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of the training engine of FIG. 1, according to some embodiments.

FIG. 3 is a flow diagram of method steps for training a diffusion model, according to some embodiments.

FIG. 4 is a more detailed illustration of the outpainting engine of FIG. 1, according to some embodiments.

FIG. 5 is a flow diagram of method steps for performing screen outpainting, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

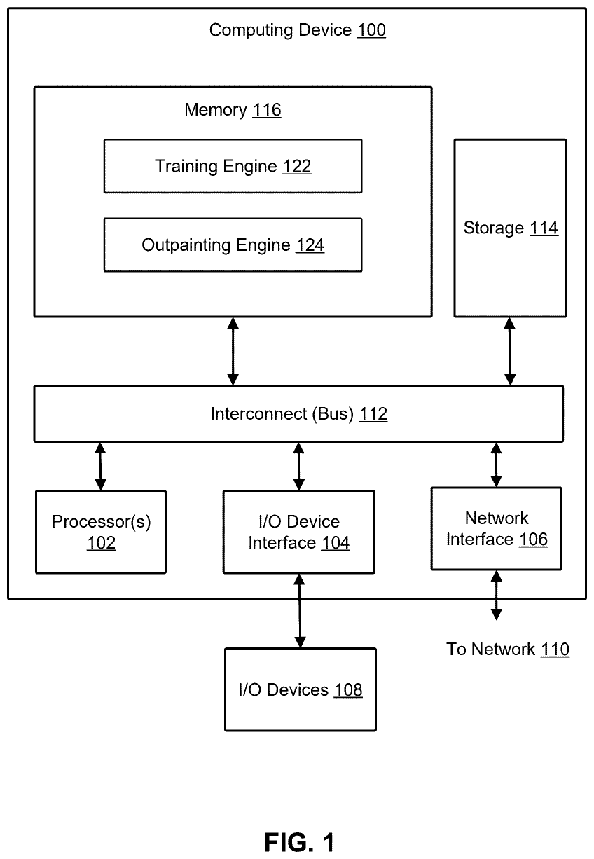

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an outpainting engine 124 that reside in a memory 116.

It is noted that the computing device described herein is illustrative and that any other technically feasible configurations fall within the scope of the present disclosure. For example, multiple instances of training engine 122 or outpainting engine 124 could execute on a set of nodes in a distributed and/or cloud computing system to implement the functionality of computing device 100. In another example, training engine 122 or outpainting engine 124 could execute on various sets of hardware, types of devices, or environments to adapt training engine 122 or outpainting engine 124 to different use cases or applications. In a third example, training engine 122 or outpainting engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. One or more of training engine 122 or outpainting engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 or outpainting engine 124.

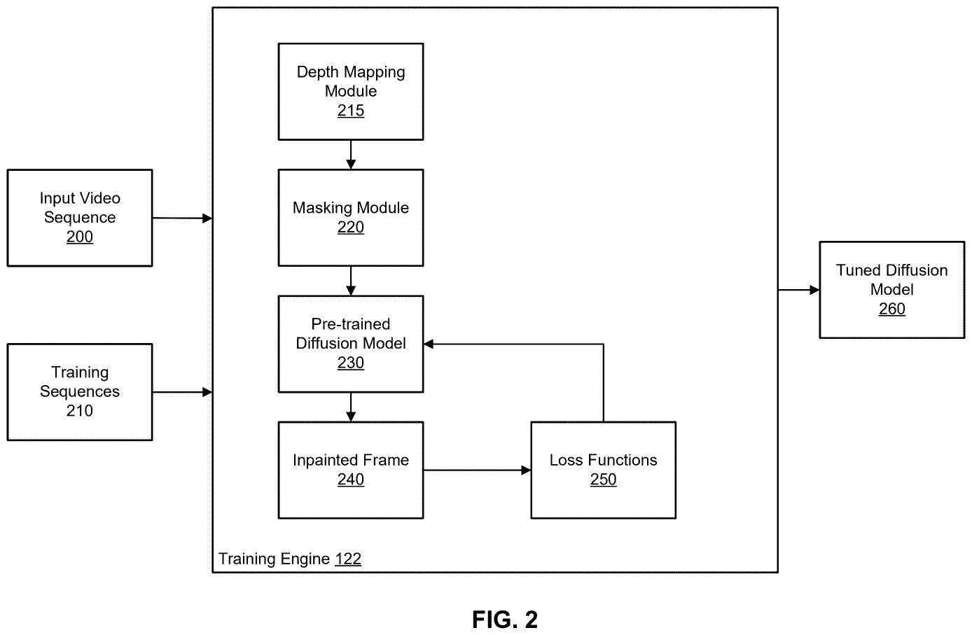

FIG. 2 is a more detailed illustration of training engine 122 of FIG. 1, according to some embodiments. In various embodiments, training engine 122 fine-tunes a pre-trained diffusion model 230 based on video sequences included in one or more of input video sequence 200 or training sequences 210. Training engine 122 generates tuned diffusion model 260 that is operable to generate novel visual content for one or more regions included in a frame of a video sequence. Training engine 122 includes, without limitation, depth mapping module 215, masking module 220, pre-trained diffusion model 230, inpainted frame 240, and loss functions 250.

Training sequences 210 include one or more video sequences each representing a shot, where a shot includes a sequence of frames captured in a temporally coherent manner, without cuts or other transitions. Each frame in the sequence of frames includes a depiction of a single scene or location, captured from a viewing position and orientation associated with a real or virtual camera. The camera position and/or orientation may vary over the course of the sequence of frames, such that one frame included in the input video sequence may depict portions of the scene or location that are not depicted in a different frame included in the input video sequence. In various embodiments, each of the one or more video sequences included in training sequences 210 may depict a different scene or location, and may be unrelated to input video sequence 200 described below.

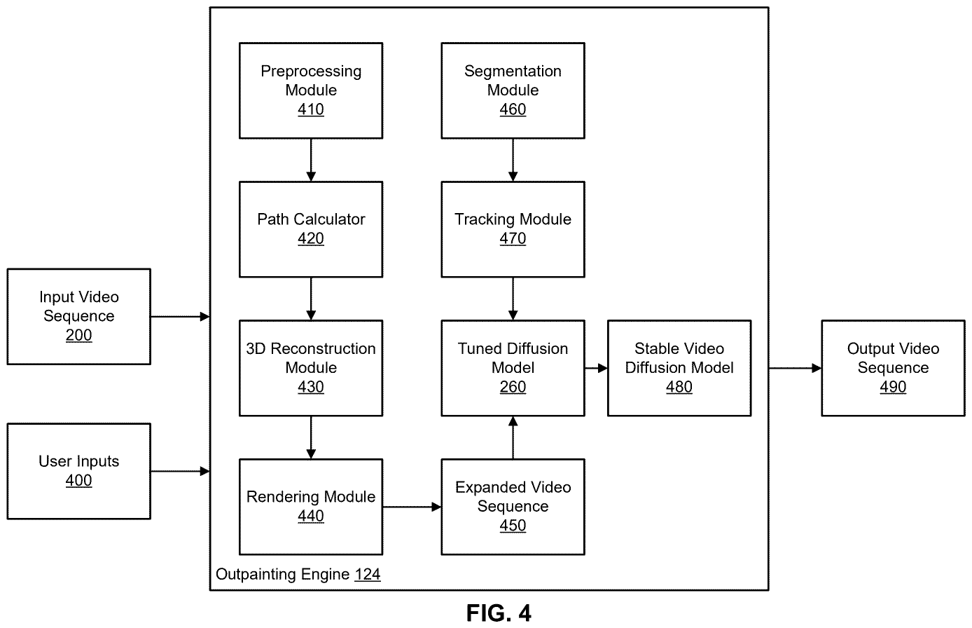

Input video sequence 200 includes a shot depicting a single scene or location, where the term “shot” has the same meaning as discussed above in reference to training sequences 210. In various embodiments, training engine 122 may fine-tune pre-trained diffusion model 230 on input video sequence 200 before outpainting engine 124 outpaints input video sequence 200 to generate an output video sequence suitable to fill the full horizontal and vertical fields of view associated with a head-mounted display (HMD) or other widescreen display device. Outpainting engine 124 is discussed in greater detail in the description of FIG. 4 below.

Input video sequence 200 includes associated horizontal and vertical resolutions, with each of the horizontal and vertical resolutions expressed as a quantity of pixels included in each frame of input video sequence 200, e.g., 1024 pixels in width by 768 pixels in height. Input video sequence 200 also includes an associated aspect ratio determined by the ratio of the horizontal resolution and the vertical resolution. For example, the above horizontal and vertical resolutions of 1024 pixels and 768 pixels respectively would determine an associated aspect ratio of 4:3. Similarly, if each frame included in input video sequence 200 has respective horizontal and vertical resolutions of 1920 pixels and 1080 pixels, the associated aspect ratio would be 16:9.

Training engine 122 receives either input video sequence 200 or one of the video sequences included in training sequences 210. Training engine 122 transmits the received video sequence to depth mapping module 215.

Depth mapping module 215 generates a depth map associated with each frame of the received video sequence. For each pixel included in a frame, the depth map includes an associated depth value representing an absolute or relative depth of an object included in the scene and associated with the pixel. In various embodiments, the depth value may be based on an absolute or relative distance from the object included in the scene and a camera plane associated with a real or virtual camera used to capture the frame. A single object included in the scene may be represented by multiple pixels, where each pixel includes its own associated depth value. Depth mapping module 215 may utilize any suitable depth mapping techniques known in the art. Depth mapping module 215 transmits the received video sequence and associated framewise depth maps to masking module 220.

Masking module 220 generates, for each frame included in the received video sequence, one or more masks, where each mask is associated with a contiguous region of pixels included in the frame. In various embodiments, masking module 220 may randomly determine the size and location within the frame of each of the one or more masks. For each of the one or more masks, masking module 220 removes the color values from pixels associated with the mask. Masking module 220 also removes the depth values included in the depth map for pixels associated with the mask. Training engine 122 records the removed color and depth values as ground truth color and depth values, along with the positions of the one or more masks. Masking module 220 transmits the masked frames and associated masked depth maps to pre-trained diffusion model 230.

Pre-trained diffusion model 230 estimates, for each of one or more masks included in a frame, color and depth values associated with pixels included in the region of the frame associated with the mask. Specifically, pre-trained diffusion model 230 learns, based on one or more adjustable internal weights included in pre-trained diffusion model 230, conditional distributions of color p(l/lₚₐᵣₜ) and depth p(d/dₚₐᵣₜ) values given the unmasked part/part of the frame and the unmasked part dₚₐᵣₜ of the depth map. Pre-trained diffusion model 230 includes a variational autoencoder (VAE) that encodes the pixelwise color information included in the partially filled frame lₚₐᵣₜ and the pixelwise depth information included in the partially filled depth map dₚₐᵣₜ for processing by pre-trained diffusion model 230.

Pre-trained diffusion model 230 inpaints the masked regions of the frame and the depth map based on the learned conditional distributions of color and depth values. For each pixel associated with a masked region of the frame, pre-trained diffusion model 230 assigns an estimated color value based on the learned conditional color distribution. In a similar manner, pre-trained diffusion model 230 assigns an estimated depth value for each pixel included in a masked region of the depth map based on the learned conditional depth distribution. Pre-trained diffusion model 230 generates inpainted frame 240 that includes original color and depth values associated with the unmasked pixels in the frame and estimated color and depth values associated with the masked pixels in the frame. Pre-trained diffusion model 230 transmits inpainted frame 240 to loss functions 250.

Loss functions 250 evaluate the pixelwise estimated color and depth values generated by pre-trained diffusion model 230 against the pixelwise ground truth color and depth values recorded by training engine 122 as described above. In various embodiments, loss functions 250 may calculate a color loss function value based on a pixel-by-pixel summation of differences between an estimated color value associated with a pixel and a ground truth color value associated with the pixel. Loss functions 250 may also calculate a depth loss function value based on a pixel-by-pixel summation of differences between an estimated depth value associated with a pixel and a ground truth depth value associated with the pixel. Based on the calculated color loss function value and the calculated depth loss function value, training engine 122 may modify one or more of the adjustable internal weights included in pre-trained diffusion model 230. Training engine 122 may iteratively repeat the above inpainting, loss function evaluation, and internal weight modification techniques for any remaining frames included in the received video sequence. Training engine 122 may process additional video sequences included in training sequences 210 or input video sequence 200 and continue to modify the internal weights included in pre-trained diffusion model 230. Training engine 122 may modify the internal weights included in pre-trained diffusion model 230 for a predetermined number of frames, a predetermined number of received video sequences, or until one or more loss function values calculated by loss functions 250 is below an associated predetermined threshold.

Training engine 122 generates tuned diffusion model 260, where tuned diffusion model includes a substantially similar architecture as pre-trained diffusion model 230. Tuned diffusion model 260 further includes the same adjustable internal weights as pre-trained diffusion model 230, modified by training engine 122 as described above.

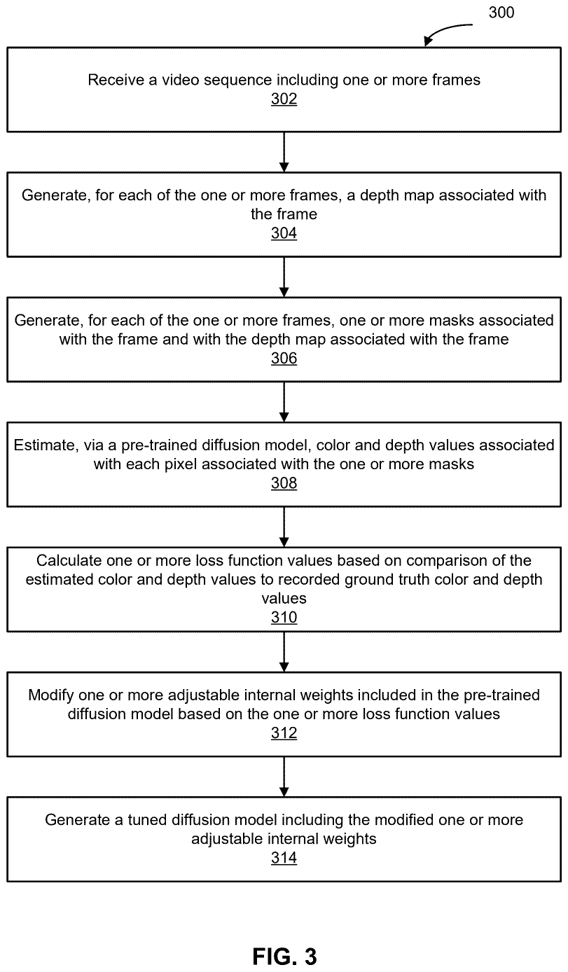

FIG. 3 is a flow diagram of method steps for training a diffusion model, according to some embodiments. Although the method steps are described in conjunction with the systems of FIGS. 1 and 2, persons skilled in the art will understand that any system configured to perform the method steps in any order falls within the scope of the present disclosure.

As shown, in step 302 of method 300, Training engine 122 receives a video sequence including one or more frames. Training engine 122 may receive input video sequence 200 that includes a video sequence to be outpainted by outpainting engine 124 described below. Alternatively, training engine 122 may receive a video sequence included in training sequences 210. The received video sequence, regardless of the source, represents a shot, where a shot includes a sequence of frames captured in a temporally coherent manner, without cuts or other transitions. Each frame in the sequence of frames includes a depiction of a single scene or location, captured from a viewing position and orientation associated with a real or virtual camera. The camera position and/or orientation may vary over the course of the sequence of frames, such that one frame included in the input video sequence may depict portions of the scene or location that are not depicted in a different frame included in the input video sequence.

In step 304, depth mapping module 215 of training engine 122 generates, for each frame included in the received video sequence, a depth map associated with the frame. For each pixel included in a frame, the depth map includes an associated depth value representing an absolute or relative depth of an object included in the scene and associated with the pixel. In various embodiments, the depth value may be based on an absolute or relative distance from the object included in the scene and a camera plane associated with a real or virtual camera used to capture the frame. A single object included in the scene may be represented by multiple pixels, where each pixel includes its own associated depth value.

In step 306, masking module 220 of training engine 122 generates, for each of the one or more frames, one or more masks associated with the frame and with the depth map associated with the frame. Each mask is associated with a contiguous region of pixels included in the frame. In various embodiments, masking module 220 may randomly determine the size and location within the frame of each of the one or more masks. For each of the one or more masks, masking module 220 removes the color values from pixels associated with the mask. Masking module 220 also removes the depth values included in the depth map for pixels associated with the mask. Training engine 122 records the removed color and depth values as ground truth color and depth values, along with the positions of the one or more masks.

In step 308, pre-trained diffusion model 230 estimates color and depth values associated with each pixel associated with the one or more masks. Pre-trained diffusion model 230 learns, based on one or more adjustable internal weights included in pre-trained diffusion model 230, conditional distributions of color p(l/lₚₐᵣₜ) and depth p (d/dₚₐᵣₜ) values given the unmasked part/part of the frame and the unmasked part dₚₐᵣₜ of the depth map. Pre-trained diffusion model 230 includes a variational autoencoder (VAE) that encodes the pixelwise color information included in the partially filled frame lₚₐᵣₜ and the pixelwise depth information included in the partially filled depth map dₚₐᵣₜ for processing by pre-trained diffusion model 230.

Pre-trained diffusion model 230 inpaints the masked regions of the frame and the depth map based on the learned conditional distributions of color and depth values. For each pixel associated with a masked region of the frame, pre-trained diffusion model 230 assigns an estimated color value based on the learned conditional color distribution. In a similar manner, pre-trained diffusion model 230 assigns an estimated depth value for each pixel included in a masked region of the depth map based on the learned conditional depth distribution.

In step 310, training engine 122 calculates one or more loss function values for loss functions 250 based on comparisons of the color and depth values estimated by pre-trained diffusion model 230 to recorded ground truth color and depth values. In various embodiments, loss functions 250 may calculate a color loss function value based on a pixel-by-pixel summation of differences between an estimated color value associated with a pixel and a ground truth color value associated with the pixel. Loss functions 250 may also calculate a depth loss function value based on a pixel-by-pixel summation of differences between an estimated depth value associated with a pixel and a ground truth depth value associated with the pixel.

In step 312, training engine 122 may modify one or more of the adjustable internal weights included in pre-trained diffusion model 230 based on the calculated color loss function value and the calculated depth loss function value. Training engine 122 may iteratively repeat the above inpainting, loss function evaluation, and internal weight modification steps for any remaining frames included in the received video sequence. Training engine 122 may process additional video sequences included in training sequences 210 or input video sequence 200 and continue to modify the internal weights included in pre-trained diffusion model 230. Training engine 122 may modify the internal weights included in pre-trained diffusion model 230 for a predetermined number of frames, a predetermined number of received video sequences, or until one or more loss function values calculated by loss functions 250 is below an associated predetermined threshold. Accordingly, training engine 122 may repeat any or all of above steps 302, 304, 306, 308, 310, and 312 when fine-tuning pre-trained diffusion model 230.

In step 314, training engine 122 generates tuned diffusion model 260 where tuned diffusion model 260 includes a substantially similar architecture as pre-trained diffusion model 230. Tuned diffusion model 260 further includes the same adjustable internal weights as pre-trained diffusion model 230, modified by training engine 122 as described above.

### Scene-Guided Outpainting of Static Elements

FIG. 4 is a more detailed illustration of outpainting engine 124 of FIG. 1, according to some embodiments. Outpainting engine 124 receives an input sequence 200 and one or more user inputs 400, and generates output video sequence 490. Output video sequence 490 includes the video content included in input video sequence 200, expanded in the horizontal direction via the addition of novel generated video content based on the video content included in input video sequence 200. Outpainting engine 124 includes, without limitation, preprocessing module 410, path calculator 420, 3D reconstruction module 430, rendering module 440, segmentation module 460, tracking module 470, tuned diffusion model 260, expanded video sequence 450, and video diffusion model 480.

Outpainting engine 124 receives input video sequence 200. As discussed above in the description of FIG. 2, input video sequence 200 includes multiple video frames representing a shot depicting a single scene or location. Input video sequence 200 includes associated horizontal and vertical resolutions, with each of the horizontal and vertical resolutions expressed as a quantity of pixels included in each frame of input video sequence 200, e.g., 1024 pixels in width by 768 pixels in height.

User inputs 400 may include user-specified horizontal and vertical display resolutions associated with a head-mounted display (HMD) or other widescreen display on which output video sequence 490 generated by outpainting engine 124 is to be displayed. Additionally or alternatively, user inputs 400 may include an aspect ratio associated with the HMD or other display device. Based on the aspect ratio, outpainting engine 124 may calculate horizontal and vertical display resolutions associated with the (HMD) or other widescreen display based on the input aspect ratio, an aspect ratio associated with input video sequence 200, and horizontal and vertical resolutions associated with input video sequence 200.

Preprocessing module 410 analyzes input video sequence 200 and determines horizontal and vertical resolutions associated with input sequence 200, where the horizontal and vertical resolutions are each expressed as a number of pixels. In various embodiments, preprocessing module 410 determines a desired resolution for output video sequence 490 based on the horizontal and vertical resolutions associated with input video sequence 200 and the user inputs included in user inputs 400. In various embodiments, preprocessing module 410 may also generate, for each frame included in input video 200, a depth map associated with the frame in a similar manner as discussed above in the description of depth mapping module 215.

Path calculator 420 analyzes input video sequence 200 and calculates a path through a 3D coordinate space associated with a real or virtual camera used to capture input video sequence 200. In various embodiments, path calculator 420 may utilize any suitable path generation technique, such as a Structure from Motion (SfM) technique. For each frame included in input video sequence 200, path calculator 420 generates 3D coordinates representing a camera position, and a camera viewing direction. In various embodiments, the camera viewing direction may be expressed as horizontal and vertical orientation displacement angles associated with the camera.

In various embodiments, path calculator 420 may also identify one or more static objects depicted in input video sequence 200. Static objects include objects that do not change position within the scene depicted in input video sequence 200. For example, the in-scene positions associated with static objects such as a tree or a road may be fixed, although the objects may appear in different locations within multiple frames included in input video sequence 200 due to the motion of the camera used to capture input video sequence 200. Path calculator 420 may analyze object locations within multiple frames included in input video sequence 200 and compensate for camera motion to determine regions included in the input video sequence frames that depict static objects. Outpainting engine 124 identifies and process dynamic objects depicted in input video sequence 200 as discussed below.

3D reconstruction module 430 generates a 3D reconstruction representing the static portions of the scene depicted in input video sequence 200. The 3D reconstruction may include any suitable representation of a 3D scene, such as a Neural Radiance Field (NeRF), one or more point clouds, or a collection of volume elements (voxels).

3D reconstruction module 430 analyzes each frame included in input video sequence 200 and generates a portion of the 3D reconstruction based on one or more static elements included in the frame. If the camera path generated by path calculator 420 as described above includes camera motion across multiple frames included in input video sequence 200, one or more portions of the depicted scene may not appear in every frame included in input video sequence 200. However, because a shot depicted in input video sequence 200 does not include any jumps, cuts, or other temporal or spatial interruptions, at least part of the scene depicted in a frame included in input video sequence 200 will also appear in an immediately subsequent frame included in input video sequence 200. Based on the overlapping scene content included in temporally adjacent frames of input video sequence 200, 3D reconstruction module 430 may stitch, blend, or otherwise combine portions of the 3D reconstruction associated with each multiple frames to generate a single 3D reconstruction representing all portions of the scene depicted in input video sequence 200. 3D reconstruction module 430 transmits the generated 3D reconstruction to rendering module 440.

Rendering module 440 may generate one or more novel views of the scene depicted in input video sequence 200 based on the 3D reconstruction received from 3D reconstruction module 430. Rendering module 440 aggregates the one or more novel views with original content included in input video sequence 200 to generate expanded video sequence 450. In various embodiments, rendering module 440 may execute one or more of a forward or backward warping technique, a 3D Gaussian splatting technique, or an unstructured lumigraph rendering technique.

Based on the horizontal and vertical resolutions calculated by preprocessing module 410 above and associated with an HMD or other widescreen display device, rendering module 440 calculates an expanded frame resolution that includes the horizontal and vertical resolutions associated with the HMD or other widescreen display device. For each frame included in input video sequence 200, rendering module generates a corresponding expanded frame having the calculated expanded frame resolution. Rendering module 440 inserts the visual content depicted in a frame of input video sequence 200 into a corresponding expanded frame generated by rendering module 440. The expanded frame includes an associated aspect ratio that is greater than the aspect ratio associated with input video sequence 200.

Rendering module 440 may scale each frame of input video sequence 200 to fill the vertical resolution associated with the corresponding expanded frame, and insert the visual content depicted in the frame at (or substantially at) the horizontal center of the expanded frame. After the insertion of visual content into the expanded frame, the central portion of the expanded frame will include visual content inserted from the corresponding frame included in input video sequence 200. The expanded frame will also include blank regions to the left and right of the central portion because of the wider aspect ratio associated with the expanded frame compared to the aspect ratio associated with the input video sequence.

Rendering module 440 may fill the blank regions included in an expanded frame with one or more novel views of the scene based on the 3D reconstruction and a camera position associated with a frame included in input video sequence 200 corresponding to the expanded frame. For each of the expanded frames, rendering module 440 calculates one or more novel rendering viewpoints, where a novel rendering viewpoint includes the camera position determined by path calculator 420 for the corresponding frame included in input video sequence 200. A novel rendering viewpoint also includes horizontal and vertical viewing angles describing an orientation of the novel rending viewpoint.

Rendering module 440 determines the horizontal and vertical viewing angles included in a novel rendering viewpoint, such that the novel rendering viewpoint is oriented to a blank region included in the expanded frame. Based on the 3D reconstruction, rendering module 440 generates a novel view of the scene represented by the 3D reconstruction and inserts the novel view into the blank region included in the expanded frame. Based on color and depth values associated with pixels included in the novel view and color and depth values associated with pixels included in the central portion of the expanded frame, rendering module 440 may stitch, blend, or otherwise combine the generated novel view of the scene with the portions of the scene depicted in the central portion of the expanded frame.

Rendering module 440 may continue to render additional novel views of the scene based on the 3D reconstruction, until all or substantially all of the blank regions included in the expanded frame have been filled with rendered scene content. Depending on the fidelity of the 3D reconstruction and the rendering algorithm, small portions of the expanded frame may remain blank, and will be filled by tuned diffusion model 260 discussed below. Rendering module 440 repeats the rendering process for each expanded frame and generates expanded video sequence 450.

Each frame included in expanded video sequence 450 includes a central portion depicting the visual content included in the corresponding frame of input video sequence 200. Each frame included in expanded video sequence 450 also includes left and right expanded portions that are at least partially filled with one or more rendered static scene elements generated by rendering module 440 as described above. Outpainting engine 124 transmits expanded video sequence 450 to tuned diffusion model 260.

In some embodiments, tuned diffusion model 260 includes pre-trained diffusion model 230, fine-tuned by training engine 122 as discussed above. One or more alternate embodiments may not include the fine-tuning techniques discussed above, in which case tuned diffusion model 260 may be substantially identical to pre-trained diffusion model 230.

Tuned diffusion model 260 identifies one or more unfilled regions included in the left and right expanded portions included in a frame included in expanded video sequence 450. Tuned diffusion model 260 generatively fills the one or more unfilled regions based on one or more internal weights included in tuned diffusion model 260. Tuned diffusion model 260 processes additional expanded frames included in expanded video sequence 450 in a similar manner and stores the processed expanded video sequence in, e.g., storage 114.

### Scene-Guided Outpainting of Dynamic Scene Elements

The above outpainting techniques generate a processed expanded video sequence where expanded left and right portions of each frame included in the processed expanded video sequence are filled with depictions of one or more static scene elements, such as a background, trees, or roads. The disclosed techniques are also operable to generate moving depictions of one or more dynamic scene elements included in a scene depicted by input video sequence 200, such as actors, animals, or vehicles.

Segmentation module 460 identifies one or more dynamic elements included in input video sequence 200. In various embodiments, segmentation module 460 may employ any suitable segmentation technique, such as semantic segmentation. Segmentation module 460 analyzes one or more frames included in input video sequence 200 and detects motion associated with one or more depicted dynamic scene elements. For each dynamic scene element, segmentation module 460 defines a region of pixels included in the frame associated with the dynamic scene element. As dynamic scene elements may move into or out of a frame at any time, a defined region of pixels included in a frame may only represent a portion of a dynamic scene element. For example, a car may be depicted leaving a particular frame, such that the frame only depicts a rear portion of the car. In this case, a region defined by segmentation module 460 may include pixels depicting the rear portion of the car. Segmentation module 460 transmits input video sequence 200 and the defined regions associated with each frame included in input video sequence 200 to tracking module 470.

For each frame included in input video sequence 200, tracking module 470 generates an expanded frame having the same horizontal and vertical dimensions as the expanded frames generated by rendering module 440 discussed above. For a frame included in input video sequence 200, tracking module 470 copies one or more pixels associated with one or more dynamic scene elements into corresponding pixel locations in the central portion of the expanded frame. Each of the one or more copied pixels includes color information associated with the pixel and depth information associated with the pixel based on the depth map generated by preprocessing module 410. Each expanded frame also includes blank regions to the left and right of the central portion of the expanded frame.

Tracking module 470 generates trajectories associated with each of the one or more dynamic scene elements identified by segmentation module 460 above, based on framewise positions, velocities, or accelerations calculated by tracking module 470 and associated with each of the dynamic scene elements. For each frame included in input video sequence 200, tracking module 470 determines positions associated with each one of the one or more dynamic scene elements, where each of the positions is expressed as coordinates within the 3D coordinate system occupied by the scene depicted in input video sequence 200. Tracking module 470 calculates inter-frame positional changes for each of the one or more dynamic scene elements across multiple frames included in input sequence 200. Based on the calculated inter-frame positional changes, tracking module 470 calculates a per-frame velocity associated with each of the one or more dynamic scene elements. Based on the calculated per-frame velocities, tracking module 470 further calculates a per-frame acceleration associated with each of the one or more dynamic scene elements. Tracking module 470 generates a trajectory associated with each of the one or more dynamic scene elements across multiple frames based on the per-frame positions, velocities, and accelerations.

Based on the generated trajectories associated with each of the one or more dynamic scene elements, tracking module 470 may extend the motion of a dynamic scene elements into the left and/or right blank regions included in the expanded frame. For example, if the central portion of the expanded frame includes a car departing the left boundary of the central portion, tracking module 470 may calculate locations within the left blank region for each of one or more subsequent expanded frames, extending the motion of the car into the left blank region. Likewise, for a car entering the central portion of the expanded frame from the left, tracking module 470 may calculate locations within the left blank region for each of one or more prior expanded frames, extending the motion of the car into the left blank region. Tracking module 470 inserts pixels representing the one or more dynamic scene elements into the left or right blank regions included in one or more expanded frames, based on the calculated trajectories. In a particular expanded frame included in the one or more expanded frames, one or more dynamic scene elements may be depicted entering or leaving the central portion of the expanded frame. For example, an expanded frame may depict a car leaving the central portion of the expanded frame and travelling to the right, such that the central portion of the expanded frame only depicts a portion, e.g., a back half, of the car. Continuing the example, tracking module 470 identifies pixels included in the right blank region of the expanded frame that need to be subsequently filled via tuned diffusion model 260 to generate the missing portion, e.g., the front half of the car.

For each of the one or more dynamic scene elements depicted entering or leaving the central portion of an expanded frame, tracking module 470 transmits the expanded frame and a designation of one or more pixels included in the left or right regions of the expanded frame to be filled to tuned diffusion model 260. Tuned diffusion model 260 estimates color and depth values associated with the designated pixels based on the part of the dynamic scene element included in the central portion of the expanded frame and one or more depictions of the dynamic scene element located wholly within the left and/or right regions. Tuned diffusion model 260 fills the designated pixel based on the estimated color and depth values, and repeats the estimation and filling process for each expanded frame that depicts the dynamic scene element entering or leaving the central portion of the expanded frame. Outpainting engine 124 may repeat the above techniques for each dynamic scene element depicted in input video sequence 200. Tuned diffusion model 260 stores the processed expanded video frames in, e.g., storage 114.

Outpainting engine 124 retrieves and combines processed expanded video sequence 450 and the processed dynamic expanded video frames previously stored by tuned diffusion model 260. Each frame included in processed expanded video sequence 450 depicts an expanded view of the static scene elements included in a scene, while each of the processed dynamic expanded video frames depicts the position of one of the of dynamic scene elements included in the scene. Outpainting engine 124 may combine each frame in processed expanded video sequence 450 with temporally corresponding frames included in the processed dynamic expanded video frames and transmit the combined expanded frames to video diffusion model 480.

Stable video diffusion model 480 may include any suitable pre-trained video diffusion model. The combined expanded frames depicting the expanded views of static and dynamic scene elements were generated individually on a frame-by-frame basis and may contain one or more temporal and/or spatial anomalies or inconsistencies. Video diffusion model 480 analyzes the entire sequence of combined expanded frames and modifies one or more frames included in the sequence of combined expanded frames based on detected anomalies and/or inconsistencies, smoothing out, reducing, or eliminating the one or more temporal and/or spatial anomalies or inconsistencies. Video diffusion model 480 generates output video sequence 490 based on the one or more modified combined expanded frames.

Output video sequence 490 includes one or more expanded frames, where each frame includes a central portion depicting unaltered visual content included in a corresponding frame included in input video sequence 200. Each frame of output video sequence 490 also includes left and right regions filled with novel visual content that is spatially and temporally consistent with the unaltered visual content included in the central portion. Each frame of output video sequence 490 includes associated horizontal and vertical resolutions based on user inputs 400, such that output video sequence 490 is suitable for viewing via an HMD or other widescreen display device.

As an optional postprocessing step (not shown), outpainting engine 124 may blur or otherwise distort the novel visual content included in the left and right regions of output video sequence 490. For example, due to creative restrictions governing the combining of original visual content with novel visual content, a user may wish to blur the novel visual content to distinguish the novel visual content from the original visual content, while still providing an immersive experience when viewing output video sequence 490 via an HMD or other widescreen display device.

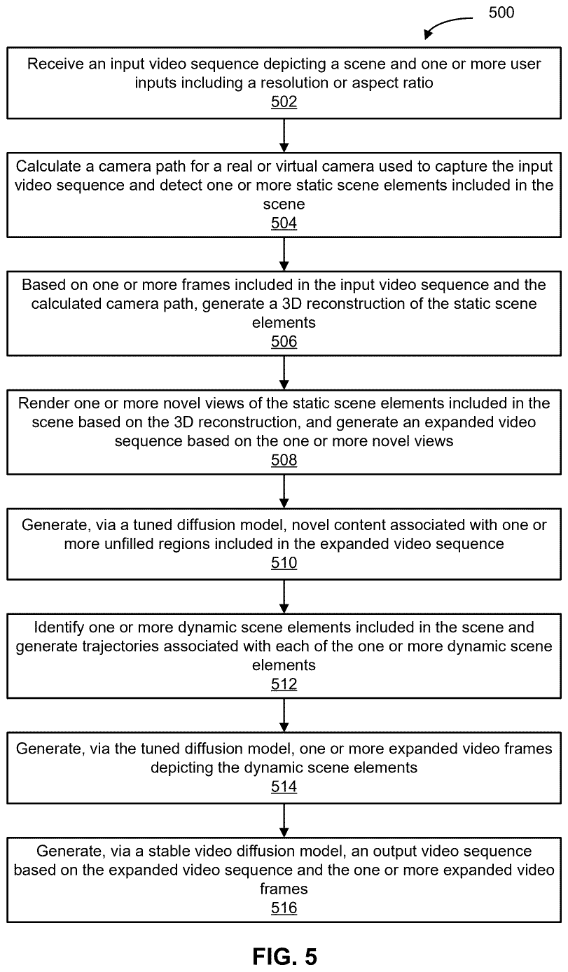

FIG. 5 is a flow diagram of method steps for performing screen outpainting, according to some embodiments. Although the method steps are described in conjunction with the systems of FIGS. 1-2 and 4, persons skilled in the art will understand that any system configured to perform the method steps in any order falls within the scope of the present disclosure.

As shown, in step 502 of method 500, outpainting engine 124 receives input video sequence 200 and user inputs 400. Input video sequence 200 includes one or more video sequences each representing a shot, where a shot includes a sequence of frames captured in a temporally coherent manner, without cuts or other transitions. Each frame in the sequence of frames includes a depiction of a single scene or location, captured from a viewing position and orientation associated with a real or virtual camera. The camera position and/or orientation may vary over the course of the sequence of frames, such that one frame included in the input video sequence may depict portions of the scene or location that are not depicted in a different frame included in the input video sequence.

User inputs 400 may include user-specified horizontal and vertical display resolutions associated with a head-mounted display (HMD) or other widescreen display on which output video sequence 490 generated by outpainting engine 124 is to be displayed. Additionally or alternatively, user inputs 400 may include an aspect ratio associated with the HMD or other display device. Based on the aspect ratio, outpainting engine 124 may calculate horizontal and vertical display resolutions associated with the (HMD) or other widescreen display based on the input aspect ratio, an aspect ratio associated with input video sequence 200, and horizontal and vertical resolutions associated with input video sequence 200.

In step 504, path calculator 420 calculates a camera path associated with a real or virtual camera used to capture input video sequence 200. In some embodiments, path calculator 420 may calculate the camera path via a Structure from Motion (SfM) technique. Based on the calculated camera path, path calculator 420 identifies one or more static scene elements included in a scene depicted in input video sequence 200. Path calculator 420 may identify the one or more static scene elements based on per-frame camera positions and orientations, as well as pixelwise depth information associated with input video sequence 200.

In step 506, 3D reconstruction module 430 generates a 3D reconstruction of the scene depicted in input video sequence 200. The 3D reconstruction may include any suitable representation of a 3D scene, such as a Neural Radiance Field (NeRF), one or more point clouds, or a collection of volume elements (voxels). 3D reconstruction module 430 analyzes each frame included in input video sequence 200 and generates a portion of the 3D reconstruction based on one or more static elements included in the frame. If the camera path generated by path calculator 420 includes camera motion across multiple frames included in input video sequence 200, one or more portions of the depicted scene may not appear in every frame included in input video sequence 200. However, because a shot depicted in input video sequence 200 does not include any jumps, cuts, or other temporal or spatial interruptions, at least part of the scene depicted in a frame included in input video sequence 200 will also appear in an immediately subsequent frame included in input video sequence 200. Based on the overlapping scene content included in temporally adjacent frames of input video sequence 200, 3D reconstruction module 430 may stitch, blend, or otherwise combine portions of the 3D reconstruction associated with each multiple frames to generate a single 3D reconstruction representing all portions of the scene depicted in input video sequence 200.

In step 508, rendering module 440 generates one or more novel views of the scene depicted in input video sequence 200 based on the 3D. Rendering module 440 aggregates the one or more novel views with original content included in input video sequence 200 to generate expanded video sequence 450.

Based on the horizontal and vertical resolutions calculated by preprocessing module 410 above and associated with an HMD or other widescreen display device, rendering module 440 calculates an expanded frame resolution that includes the horizontal and vertical resolutions associated with the HMD or other widescreen display device. For each frame included in input video sequence 200, rendering module generates a corresponding expanded frame having the calculated expanded frame resolution. Rendering module 440 inserts the visual content depicted in a frame of input video sequence 200 into a corresponding expanded frame generated by rendering module 440. The expanded frame includes an associated aspect ratio that is greater than the aspect ratio associated with input video sequence 200.

Rendering module 440 may scale each frame of input video sequence 200 to fill the vertical resolution associated with the corresponding expanded frame, and insert the visual content depicted in the frame at (or substantially at) the horizontal center of the expanded frame. After the insertion of visual content into the expanded frame, the central portion of the expanded frame will include visual content inserted from the corresponding frame included in input video sequence 200. The expanded frame will also include blank regions to the left and right of the central portion because of the wider aspect ratio associated with the expanded frame compared to the aspect ratio associated with the input video sequence.

Rendering module 440 may fill the blank regions included in an expanded frame with one or more novel views of the scene based on the 3D reconstruction and a camera position associated with a frame included in input video sequence 200 corresponding to the expanded frame. For each of the expanded frames, rendering module 440 calculates one or more novel rendering viewpoints, where a novel rendering viewpoint includes the camera position determined by path calculator 420 for the corresponding frame included in input video sequence 200. A novel rendering viewpoint also includes horizontal and vertical viewing angles describing an orientation of the novel rending viewpoint.

Rendering module 440 determines the horizontal and vertical viewing angles included in a novel rendering viewpoint, such that the novel rendering viewpoint is oriented to a blank region included in the expanded frame. Based on the 3D reconstruction, rendering module 440 generates a novel view of the scene represented by the 3D reconstruction and inserts the novel view into the blank region included in the expanded frame. Based on color and depth values associated with pixels included in the novel view and color and depth values associated with pixels included in the central portion of the expanded frame, rendering module 440 may stitch, blend, or otherwise combine the generated novel view of the scene with the portions of the scene depicted in the central portion of the expanded frame.

Rendering module 440 may continue to render additional novel views of the scene based on the 3D reconstruction, until all or substantially all of the blank regions included in the expanded frame have been filled with rendered scene content. Depending on the fidelity of the 3D reconstruction and the rendering algorithm, small portions of the expanded frame may remain blank, and will be filled by tuned diffusion model 260 discussed below. Rendering module 440 repeats the rendering process for each expanded frame and generates expanded video sequence 450.

Each frame included in expanded video sequence 450 includes a central portion depicting the visual content included in the corresponding frame of input video sequence 200. Each frame included in expanded video sequence 450 also includes left and right expanded portions that are at least partially filled with one or more rendered static scene elements generated by rendering module 440 as described above.

In step 510, tuned diffusion model 260 generates novel content associated with one or more unfilled regions included in the expanded video sequence. Tuned diffusion model 260 identifies one or more unfilled regions included in the left and right expanded portions within a frame included in expanded video sequence 450. Tuned diffusion model 260 generatively fills the one or more unfilled regions based on one or more internal weights included in tuned diffusion model 260 and visual content included in the filled regions of the frame included in expanded video sequence 450.

In step 512, segmentation module 460 identifies one or more dynamic scene elements included in input video sequence 200. Segmentation module 460 analyzes one or more frames included in input video sequence 200 and detects motion associated with one or more depicted dynamic scene elements. For each dynamic scene element, segmentation module 460 defines a region of pixels included in the frame associated with the dynamic scene element.

For each frame included in input video sequence 200, tracking module 470 generates an expanded frame having the same horizontal and vertical dimensions as the expanded frames generated by rendering module 440 discussed above. For a frame included in input video sequence 200, tracking module 470 copies one or more pixels associated with one or more dynamic scene elements into corresponding pixel locations in the central portion of the expanded frame. Each of the one or more copied pixels includes color information associated with the pixel and depth information associated with the pixel based on the depth map generated by preprocessing module 410. Each expanded frame also includes blank regions to the left and right of the central portion of the expanded frame.

Tracking module 470 generates trajectories associated with each of the one or more dynamic scene elements identified by segmentation module 460 above, based on framewise positions, velocities, or accelerations calculated by tracking module 470 and associated with each of the dynamic scene elements. Tracking module 470 calculates inter-frame positional changes for each of the one or more dynamic scene elements across multiple frames included in input sequence 200. Based on the calculated inter-frame positional changes, tracking module 470 calculates a per-frame velocity associated with each of the one or more dynamic scene elements. Based on the calculated per-frame velocities, tracking module 470 further calculates a per-frame acceleration associated with each of the one or more dynamic scene elements. Tracking module 470 generates a trajectory associated with each of the one or more dynamic scene elements across multiple frames based on the per-frame positions, velocities, and accelerations.

Based on the generated trajectories associated with each of the one or more dynamic scene elements, tracking module 470 may extend the motion of a dynamic scene elements into the left and/or right blank regions included in the expanded frame. Tracking module 470 inserts pixels representing the one or more dynamic scene elements into the left or right blank regions included in one or more expanded frames, based on the calculated trajectories.

In step 514, tracking module 470 transmits the expanded frame and a designation of one or more pixels included in the left or right regions of the expanded frame to be filled to tuned diffusion model 260. Tuned diffusion model 260 estimates color and depth values associated with the designated pixels based on the part of the dynamic scene element included in the central portion of the expanded frame and one or more depictions of the dynamic scene element located wholly within the left and/or right regions. Tuned diffusion model 260 fills the designated pixel based on the estimated color and depth values, and repeats the estimation and filling process for each expanded frame that depicts the dynamic scene element entering or leaving the central portion of the expanded frame.

In step 516, outpainting engine 124 combines the expanded video sequence including static scene elements with the one or more expanded video frames depicting dynamic scene elements and transmits the combination to video diffusion model 480. Video diffusion model 480 smooths, reduces, or eliminates spatial and/or temporal anomalies included in the expanded video sequence or the one or more expanded video frames. Video diffusion model 480 generates output video sequence 490. Output video sequence 490 includes one or more expanded frames, where each frame includes a central portion depicting unaltered visual content included in a corresponding frame included in input video sequence 200. Each frame of output video sequence 490 also includes left and right expanded regions filled with novel visual content that is spatially and temporally consistent with the unaltered visual content included in the central portion. Each frame of output video sequence 490 includes associated horizontal and vertical resolutions based on user inputs 400, such that output video sequence 490 is suitable for viewing via an HMD or other widescreen display device.

In sum, the disclosed techniques perform screen outpainting on a sequence of input video frames to generate an output video sequence suitable for display on a head-mounted display (HMD) or similar display having a wide (e.g., 180-degree) horizontal viewing angle. The disclosed techniques extend each of the input video frames by generating novel content on the left and right sides of the original content included in the input video frame, such that a horizontal resolution, vertical resolution, and aspect ratio associated with an extended frame are suitable to fill the entire vertical and horizontal fields of view of an HMD or similar display. The disclosed techniques generate the novel content based on the original content included in the input video frames, such that the output video sequence includes an immersive depiction of a scene included in the sequence of input video frames.

In operation, a reconstruction engine receives an input video sequence representing a shot, where a shot includes a sequence of frames captured in a temporally coherent manner, without cuts or other transitions. Each frame in the sequence of frames includes a depiction of a single scene or location, captured from a viewing position and orientation associated with a real or virtual camera. The camera position and/or orientation may vary over the course of the sequence of frames, such that one frame included in the input video sequence may depict portions of the scene or location that are not depicted in a different frame included in the input video sequence.

The reconstruction engine processes the input video sequence and generates a three-dimensional (3D) reconstruction of a scene depicted in the input video sequence. The reconstruction engine analyzes each frame of the input video sequence via any suitable Structure from Motion (SfM) technique and reconstructs a 3D camera path associated with the camera used to capture the input video sequence.

The reconstruction engine estimates a 3D reconstruction of the scene based on the contents of the frames included in the input video sequence. The 3D reconstruction may include multiple pixels or other elements, where each element includes color and depth information associated with a portion of the depicted scene. The 3D reconstruction may represent all portions of a depicted scene that appear in at least one frame of the input video sequence, even if no one individual frame depicts the entire scene. For example, given an input video sequence including multiple frames captured by a camera panning from left to right across a scene, the estimated 3D reconstruction may represent the entire scene, even though each individual frame included in the input video sequence only depicts a portion of the entire scene. The reconstruction engine also identifies static elements included in scene that do not change their positions within the scene during the shot, such as a tree or a road. The reconstruction engine transmits the reconstructed camera path and estimated 3D reconstruction to an outpainting engine.

The outpainting engine generates renders of novel viewpoints of the scene based on the estimated 3D reconstruction, expanding the frames included in the input video sequence with additional, novel content to the left and right of the frames such that the expanded frames are suitable for viewing on an HMD or other widescreen display device.

The outpainting engine generates novel views of the 3D scene reconstruction based on the reconstructed path of the camera used to capture the input video sequence. For each original frame included in the input video sequence, the outpainting engine determines one or more novel viewpoints based on a camera position associated with the frame and specified by the reconstructed 3D camera path. Each viewpoint includes both the camera position and a novel viewing orientation. The outpainting engine determines the novel viewing orientation such that a novel view of the 3D reconstruction based on the camera position and determined viewing orientation depicts one or more portions of the scene that are not depicted in the original frame. For example, given an original frame that depicts a central portion of a scene, the outpainting engine may render novel views of the 3D reconstruction that depict portions of the scene located to the left and right of the central portion of the scene. The outpainting engine may combine the one or more rendered novel views with the contents of the original frame to generate an output frame having a wider aspect ratio than the original frame and displaying a greater portion of the depicted scene.

Depending on the quality and completeness of the estimated 3D reconstruction of the scene, novel views rendered by the outpainting engine may include one or more blank regions. The outpainting engine fills in these blank regions via a pre-trained machine learning model, such as a pre-trained latent diffusion model. The pre-trained machine learning model determines color and depth values for pixels included in the blank regions based on color and depth values associated with pixels included in non-blank regions of the novel view. The outpainting engine may update the estimated 3D representation based on the color and depth values determined for the blank regions. Updating the estimated 3D representation with the color and depth values associated with a previously blank region improves the outpainting results generated for subsequent frames, as the updated 3D reconstruction may result in fewer blank regions that need to be filled. Updating the 3D reconstruction also ensures temporal coherence across multiple output frames, because novel views generated for later frames in the input video sequence are rendered based on the 3D reconstruction as updated during the processing of earlier frames in the input video sequence.

The above techniques are suitable for outpainting an original frame based on the static elements included in a scene. The disclosed techniques also perform dynamic depth-aware outpainting of original frames based on dynamic elements included in the scene, such as characters, vehicles, or other moving objects. Characters or objects may enter or leave an original frame at any time, necessitating the prediction of object motion outside of the original frame during outpainting.

The outpainting engine employs semantic segmentation and tracking to identify one or more moving objects depicted in an input video sequence, as well as to identify when a moving object enters or leaves a particular frame included in the input video sequence. The outpainting engine creates an outpainting process for each moving object as the object enters or leaves the original frame. When entering or leaving the original frame, a portion of the object will be included in the original frame. The outpainting engine generates the remaining portion of the object within the outpainted region to the left or right of the original frame, such that the object bridges the boundary between the original frame and the outpainted region. The outpainting engine may predict the motion of an object outside of the original frame via optical flow techniques and velocity/acceleration vectors generated from previous frames in the input video sequence. The generated portion of the object includes estimated color and depth information associated with pixels included in the generated portion of the object, allowing the outpainting engine to recompose both the static and dynamic elements into a coherent final color image.

To improve the temporal consistency of moving objects across multiple frames, the outpainting engine includes a video diffusion model. The outpainting engine provides the sequence of expanded/outpainted video frames to the video diffusion model, where the video frames may include moving objects located in the central part of the expanded frame corresponding to the original frame, moving objects located partially in the central part of the expanded frame and partially in the outpainted part of the expanded frame, or moving objects located entirely within the outpainted part of the expanded frame. The video diffusion model analyzes the sequence of expanded/outpainted video frames and modifies the portions of the moving objects that are located within the outpainted parts of the expanded/outpainted frames to maintain a consistent appearance of the object across frames. The disclosed techniques do not make any modifications to image content included in the central part of an expanded/outpainted video frame, as this image content originated from an input video frame and represents ground truth data.

As an optional post-processing step, the disclosed techniques may, for creative or other reasons, blur or otherwise distort the outpainted portions of an expanded/outpainted video frame to distinguish the outpainted portions from the original content while still providing an immersive experience while viewing the expanded video via, e.g., a head-mounted display.

One technical advantage of the disclosed techniques relative to the prior art is that the disclosed techniques are operable to extend an existing video sequence to fill the field of view of a head-mounted display (HMD) or other widescreen display without discarding or distorting content included in the existing video sequence. The disclosed techniques also generate extended video content that is both temporally and spatially consistent with the content of the existing video sequence, incorporating both static and dynamic elements included in the existing video sequence. These technical advantages provide one or more technological improvements over prior art approaches
1. In some embodiments, a computer-implemented method for performing screen outpainting comprises receiving an input video sequence including one or more frames depicting a scene, identifying one or more static scene elements included in the scene, generating a three-dimensional (3D) reconstruction of the scene based on the input video sequence and the one or more static scene elements, rendering one or more novel views of the scene based on the 3D reconstruction of the scene, generating one or more expanded frames, wherein each expanded frame includes a first region including visual content included in a frame included in the input video sequence, and one or more additional regions that each include visual content based on the one or more novel views of the scene, and generating an output video sequence based on the one or more expanded frames.
2. The computer-implemented method of clause 1, wherein the scene further includes one or more dynamic scene elements.
3. The computer-implemented method of clauses 1 or 2, further comprising generating a trajectory associated with at least one of the one or more dynamic scene elements.
4. The computer-implemented method of any of clauses 1-3, wherein the one or more additional regions included in the one or more expanded frames include visual content based on the one or more dynamic scene elements.
5. The computer-implemented method of any of clauses 1-4, further comprising generating a depth map associated with each of the one or more frames included in the input video sequence.
6. The computer-implemented method of any of clauses 1-5, wherein generating the 3D reconstruction is based at least on the generated depth maps associated with each of the one or more frames included in the input video sequence.
7. The computer-implemented method of any of clauses 1-6, wherein each of the one or more expanded frames includes a horizontal resolution that is greater than a horizontal resolution associated with a corresponding frame included in the input video sequence.
8. The computer-implemented method of any of clauses 1-7, further comprising generating, via a diffusion machine learning model, novel content associated with at least one of the one more additional regions included in the expanded frame.
9. The computer-implemented method of any of clauses 1-8, wherein generating the one or more novel views of the scene is based at least on a calculated camera path associated with a real or virtual camera used to capture the input video sequence.
10. The computer-implemented method of any of clauses 1-9, further comprising blurring the one or more additional regions included in each of the one or more expanded frames.
11. In some embodiments, one or more non-transitory computer-readable media include instructions that, when executed by one or more processors, cause the one or more processors to perform the steps of receiving an input video sequence including one or more frames depicting a scene, identifying one or more static scene elements included in the scene, generating a three-dimensional (3D) reconstruction of the scene based on the input video sequence and the one or more static scene elements, rendering one or more novel views of the scene based on the 3D reconstruction of the scene, generating one or more expanded frames, wherein each expanded frame includes a first region including visual content included in a frame included in the input video sequence, and one or more additional regions that each include visual content based on the one or more novel views of the scene, and generating an output video sequence based on the one or more expanded frames.
12. The one or more non-transitory computer-readable media of clause 11, wherein the scene further includes one or more dynamic scene elements.
13. The one or more non-transitory computer-readable media of clauses 11 or 12, wherein the steps further comprise generating a trajectory associated with at least one of the one or more dynamic scene elements.
14. The one or more non-transitory computer-readable media of any of clauses 11-13, wherein the one or more additional regions included in the one or more expanded frames include visual content based on the one or more dynamic scene elements.
15. The one or more non-transitory computer-readable media of any of clauses 11-14, wherein the steps further comprise generating a depth map associated with each of the one or more frames included in the input video sequence.
16. The one or more non-transitory computer-readable media of any of clauses 11-15, wherein generating the 3D reconstruction is based at least on the generated depth maps associated with each of the one or more frames included in the input video sequence.
17. The one or more non-transitory computer-readable media of any of clauses 11-16, further comprising generating, via a diffusion machine learning model, novel content associated with at least one of the one more additional regions included in the expanded frame.
18. In some embodiments, a system comprises one or more memories storing instructions, and one or more processors for executing the instructions to receive an input video sequence including one or more frames depicting a scene, identify one or more static scene elements included in the scene, generate a three-dimensional (3D) reconstruction of the scene based on the input video sequence and the one or more static scene elements, render one or more novel views of the scene based on the 3D reconstruction of the scene, generate one or more expanded frames, wherein each expanded frame includes a first region including visual content included in a frame included in the input video sequence, and one or more additional regions that each include visual content based on the one or more novel views of the scene, and generate an output video sequence based on the one or more expanded frames.
19. The system of clause 18, wherein the one or more processors further execute the instructions to generate, via a diffusion machine learning model, novel content associated with at least one of the one more additional regions included in the expanded frame.
20. The system of clauses 18 or 19, wherein generating the one or more novel views of the scene is based at least on a calculated camera path associated with a real or virtual camera used to capture the input video sequence.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing screen outpainting, the method comprising:
receiving an input video sequence including one or more frames depicting a scene;
identifying one or more static scene elements included in the scene;
generating a three-dimensional (3D) reconstruction of the scene based on the input video sequence and the one or more static scene elements;
rendering one or more novel views of the scene based on the 3D reconstruction of the scene;
generating one or more expanded frames, wherein each expanded frame includes a first region including visual content included in a frame included in the input video sequence, and one or more additional regions that each include visual content based on the one or more novel views of the scene; and
generating an output video sequence based on the one or more expanded frames.

2. The computer-implemented method of claim 1, wherein the scene further includes one or more dynamic scene elements.

3. The computer-implemented method of claim 2, further comprising generating a trajectory associated with at least one of the one or more dynamic scene elements.

4. The computer-implemented method of claim 2, wherein the one or more additional regions included in the one or more expanded frames include visual content based on the one or more dynamic scene elements.

5. The computer-implemented method of claim 1, further comprising generating a depth map associated with each of the one or more frames included in the input video sequence.

6. The computer-implemented method of claim 5, wherein generating the 3D reconstruction is based at least on the generated depth maps associated with each of the one or more frames included in the input video sequence.

7. The computer-implemented method of claim 1, wherein each of the one or more expanded frames includes a horizontal resolution that is greater than a horizontal resolution associated with a corresponding frame included in the input video sequence.

8. The computer-implemented method of claim 1, further comprising generating, via a diffusion machine learning model, novel content associated with at least one of the one more additional regions included in the expanded frame.

9. The computer-implemented method of claim 1, wherein generating the one or more novel views of the scene is based at least on a calculated camera path associated with a real or virtual camera used to capture the input video sequence.

10. The computer-implemented method of claim 1, further comprising blurring the one or more additional regions included in each of the one or more expanded frames.

11. One or more non-transitory computer-readable media including instructions that, when executed by one or more processors, cause the one or more processors to perform the steps of:
receiving an input video sequence including one or more frames depicting a scene;
identifying one or more static scene elements included in the scene;
generating a three-dimensional (3D) reconstruction of the scene based on the input video sequence and the one or more static scene elements;
rendering one or more novel views of the scene based on the 3D reconstruction of the scene;
generating one or more expanded frames, wherein each expanded frame includes a first region including visual content included in a frame included in the input video sequence, and one or more additional regions that each include visual content based on the one or more novel views of the scene; and
generating an output video sequence based on the one or more expanded frames.

12. The one or more non-transitory computer-readable media of claim 11, wherein the scene further includes one or more dynamic scene elements.

13. The one or more non-transitory computer-readable media of claim 12, wherein the steps further comprise generating a trajectory associated with at least one of the one or more dynamic scene elements.

14. The one or more non-transitory computer-readable media of claim 12, wherein the one or more additional regions included in the one or more expanded frames include visual content based on the one or more dynamic scene elements.

15. The one or more non-transitory computer-readable media of claim 11, wherein the steps further comprise generating a depth map associated with each of the one or more frames included in the input video sequence.

16. The one or more non-transitory computer-readable media of claim 15, wherein generating the 3D reconstruction is based at least on the generated depth maps associated with each of the one or more frames included in the input video sequence.

17. The one or more non-transitory computer-readable media of claim 11, further comprising generating, via a diffusion machine learning model, novel content associated with at least one of the one more additional regions included in the expanded frame.

18. A system comprising:
one or more memories storing instructions; and
one or more processors for executing the instructions to:
receive an input video sequence including one or more frames depicting a scene;
identify one or more static scene elements included in the scene;
generate a three-dimensional (3D) reconstruction of the scene based on the input video sequence and the one or more static scene elements;
render one or more novel views of the scene based on the 3D reconstruction of the scene;
generate one or more expanded frames, wherein each expanded frame includes a first region including visual content included in a frame included in the input video sequence, and one or more additional regions that each include visual content based on the one or more novel views of the scene; and
generate an output video sequence based on the one or more expanded frames.

19. The system of claim 18, wherein the one or more processors further execute the instructions to generate, via a diffusion machine learning model, novel content associated with at least one of the one more additional regions included in the expanded frame.

20. The system of claim 18, wherein generating the one or more novel views of the scene is based at least on a calculated camera path associated with a real or virtual camera used to capture the input video sequence.
